(19) United States
(12) Patent Application Publication
(10) Pub. No.: US 2009/0046820 A1
(43) Pub. Date: Feb. 19, 2009

(54) Serial Data Sampling Point Control

(76) Inventors: Mark Clark, Blackburn (GB); Mark Leverington, Blackburn (GB)

Correspondence Address: NIXON & VANDERHYE P.C., 901 N. Glebe Road, 11th Floor, Arlington, VA, 22203-1808, US

(21) Appl. No.: 12/087,052

(22) PCT Filed: Feb. 15, 2006
(86) PCT No.: PCT/GB2006/000524

§ 371 Date: Jun. 25, 2008

(51) Int. Cl. H04L 7/00

(52) U.S. Cl. 375/355

(57) ABSTRACT

Serial data transmission is performed using a serial data signal (8) with an associated clock signal (10) having sampling-trigger characteristics within the clock signal for controlling when the serial data signal is sampled by the receiver (2). Instead of reducing the clock signal frequency to a level where minimum setup time and minimum hold time requirements are met for every serial bit irrespective of its value, the technique instead runs at a higher frequency assuming that the bit value will not change and when a change in bit value does occur extends the time between sampling-trigger characteristics and extends assertion of either the preceding bit in the case of hold time requirements or the following bit in the case of setup time requirements. The technique is particularly useful in serial communication of diagnostic data with integrated circuits (2).

This invention relates to the field of serial data transmission. More particularly, this invention relates to the control of sampling points of a serial data signal(s) with a clock signal.

It is known to provide serial data signals with an accompanying clock signal (e.g. a source synchronous system). The clock signal has characteristics which define sampling points at which a receiver of the serial data signal and the clock signal samples the serial data signal to capture a bit value. Examples of the characteristics of the clock signal which can be used as sampling-trigger characteristics include rising edges, falling edges or both.

A problem which can arise within serial data transmission systems is that a particular receiver may have setup time requirements or hold time requirements which impact the data rate that can be achieved, these time requirements may be increased further to match the imperfect propagation path. A setup time requirement is one which specifies a minimum time for which the serial signal should have been at a new value before that new value can be reliably sampled. A hold time requirement is one specifying a minimum time after which a signal value has been asserted on the serial data signal for which it must be held at that value such that reliable sampling can have been assured. It will be appreciated that the sum of the minimum setup time and the minimum hold time for all the serial signals associated with a clock signal will constrain the maximum frequency of that clock signal. Thus, if one particular serial signal with its sampling derived from the clock signal has unduly onerous setup or hold time requirements, then this may impact the performance of other parts of the system since the clock signal must cater for this requirement (the clock signal may also be constrained by other factors).

Viewed from one aspect the present invention provides apparatus for generating a serial data signal and a clock signal, said clock signal having sampling-trigger characteristics indicating respective sampling points for extracting data bits from said serial data signal, said apparatus comprising:

a pipeline operable to queue a sequence of data bits to be output using said serial data signal;

a bit value change detector coupled to said pipeline store and operable to detect changes of value between adjacent data bits queued within said pipeline;

a sampling point controller responsive to said detected changes of value to extend a time between said sampling-trigger characteristics of said clock signal and to extend a time for which a value of one of said adjacent data bits is asserted as said serial data signal.

The present technique recognises that when a data value of a serial signal is not changing between adjacent data bits, then the setup time for the later bit will already have been satisfied by the assertion of the preceding bit and/or conversely the hold time for the preceding bit will be satisfied by the assertion of the later bit. This can be exploited by using a faster clock signal than would otherwise be permitted and including a mechanism which detects changes in adjacent bit values and slows the clock signal appropriately by extending the time to the next sampling-trigger point and either continuing to assert the preceding bit in the case of a minimum hold time requirement or extending the period of assertion of the new bit in the case of a minimum setup time requirement. Assuming that each possible value of the data bit is equally likely to occur, then for substantially half the pairs of adjacent data bits there will be no change in value and accordingly no extension of the sampling-trigger characteristic (point) is necessary. This allows more rapid data transfer.

It will be appreciated that the present technique could be implemented at least partially in software, e.g. the pipeline could be bit values to be output stored in a general purpose memory, with the bit value change detector being software and with the clock signal being generated by buffering an appropriate sequence of values in memory and then outputting those values as the clock signal. Other partial or full software implementations are also possible.

Another possibility for both hardware, software or mixed implementations I that for a sequence of data values which is likely to be repeated, the data values and associated clock signal pattern could be stored and replayed as required without the need for another analysis pass through the data stream detecting data value changes.

As previously mentioned, the sampling-trigger characteristics can be, for example, one or both of a rising edge of the clock signal and a falling edge of the clock signal.

In the case where only one of the rising edge or the falling edge of the clock signal is used as a sampling-trigger characteristic, then it is convenient to provide some embodiments of the invention (particularly FPGA embodiments) in which the minimum internal clock frequency of the apparatus for generating the serial data signal and the clock signal is at least twice that corresponding to a clock where the maximum setup and/or hold time requirements are continuously observed. More accuracy could be achieved if the internal clock frequency was even higher.

If, instead of only one of the rising edge or the falling edge being used as a sampling-trigger characteristic, both were used as a sampling-trigger characteristic (i.e. in a manner similar to the operation of DDR memory), then the internal clock frequency of the apparatus for generating the serial data signal (particularly FPGA embodiments) and the clock signal need only be equal to or greater than the clock frequency which would be obtained by observing continuously the minimum hold time requirements and the minimum setup time requirements. This would be useful for embodiments that are limited in their internal clock speed.

Whilst the present techniques could be used for any type of serial data transmission, the present technique is particularly suited for use when the serial data signal is a diagnostic signal used in performing diagnostic operations upon an integrated circuit. Within such systems setup and/or hold time requirements for signals which relatively infrequently change can occur and without the present technique act to constrain the data rate of other signals which would be able to maintain higher data throughput using a faster clock signal.

The diagnostic uses can vary and include, for example, debug operations, trace operations, manufacturing test operations and device programming operations.

Whilst it will be appreciated that the present technique could be used in a system with a clock signal and a single serial data signal, the technique is also applicable in systems having a clock signal with multiple associated serial data signals. In such systems, such as the one above where the requirements of one of the serial data signals force the same requirements on the other serial data signals, the present techniques can be used with particular advantage.

Viewed from another aspect the present invention provides apparatus for generating a serial data signal and a clock signal, said clock signal having sampling-trigger characteristics indicating respective sampling points for extracting data bits from said serial data signal, said apparatus comprising:

pipeline means for queuing a sequence of data bits to be output using said serial data signal;

bit value change detector means coupled to said pipeline store for detecting changes of value between adjacent data bits queued within said pipeline means;

sampling point controller means responsive to said detected changes of value for extending a time between said sampling-trigger characteristics of said clock signal and correspondingly extending a time for which a value of one of said adjacent data bits is asserted as said serial data signal.

Viewed from a further aspect the present invention provides a method of generating a serial data signal and a clock signal, said clock signal having sampling-trigger characteristics indicating respective sampling points for extracting data bits from said serial data signal, said comprising the steps of:

queuing a sequence of data bits to be output using said serial data signal;

detecting changes of value between adjacent data bits queued;

in response to said detected changes of value, extending a time between said sampling-trigger characteristics of said clock signal and extending a time for which a value of one of said adjacent data bits is asserted as said serial data signal.

Embodiments of the invention will now be described, by way of example only, with reference to the accompanying drawings in which:

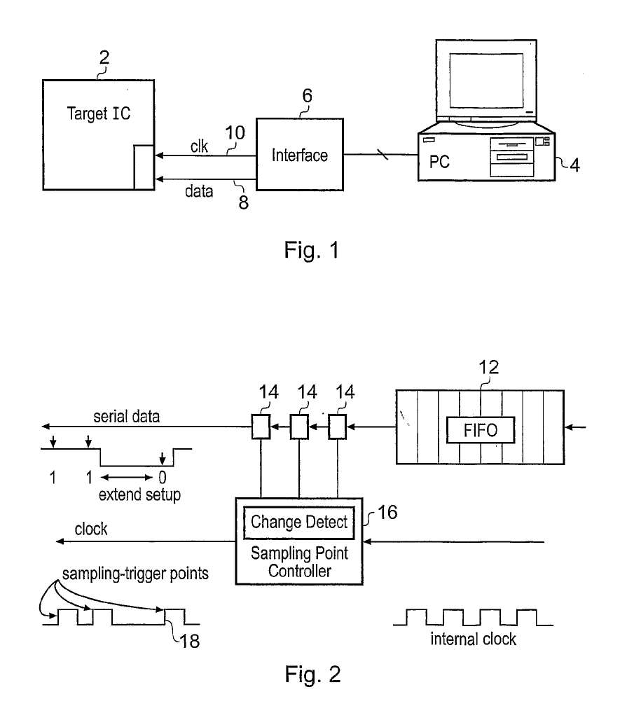

FIG. 1 schematically illustrates diagnostic operations being performed upon an integrated circuit;

FIG. 2 schematically illustrates a portion of an interface circuit of FIG. 1 employing the current techniques;

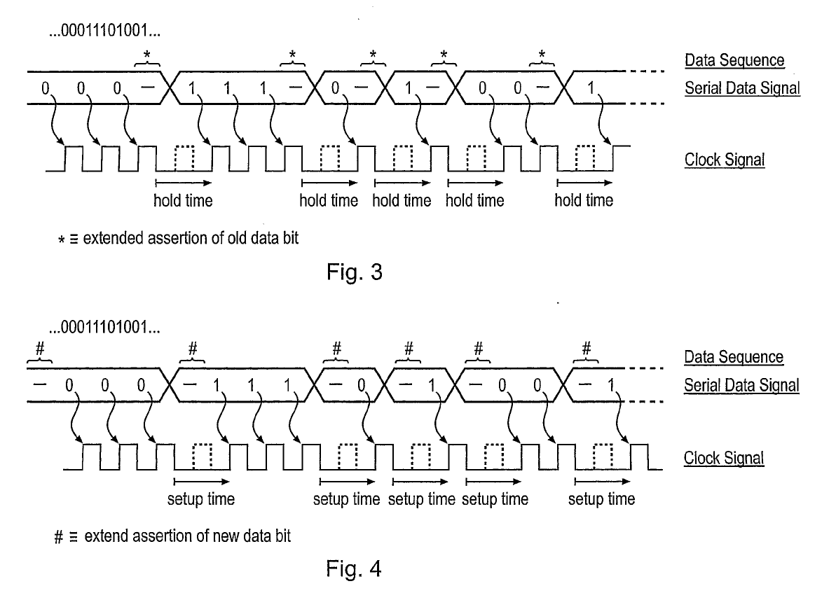

FIG. 3 is a signal diagram schematically illustrating how the current technique can be used to deal with minimum hold time requirements;

FIG. 4 is a signal diagram schematically illustrating how the current technique can be used to deal with minimum setup time requirements;

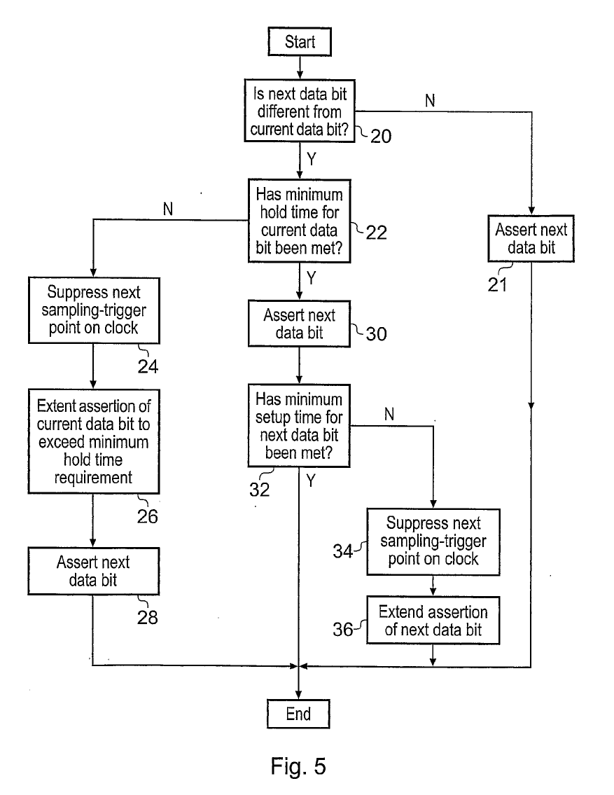

FIG. 5 is a flow diagram illustrating control processes performed by the sampling point controller of FIG. 2 in a clock gating embodiment; and

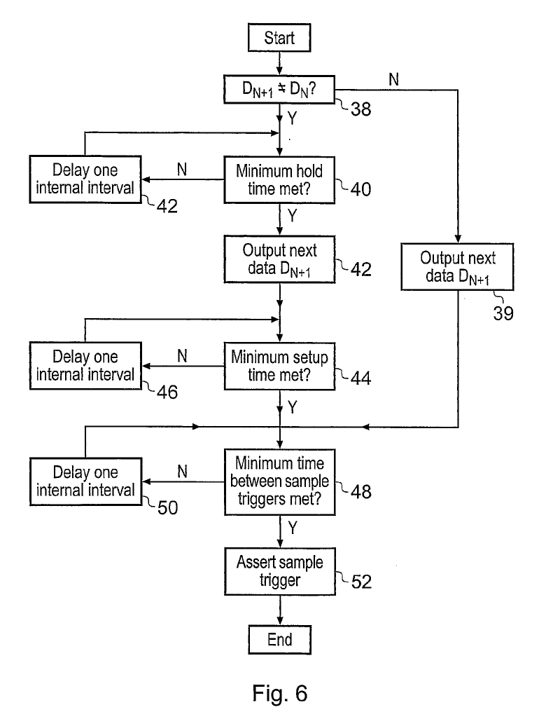

FIG. 6 is a flow diagram illustrating control processes performed by the sampling point controller of FIG. 2 in an embodiment more suited to FPGA implementation.

FIG. 1 schematically illustrates a target integrated circuit 2 which is subject to diagnostic operations. A general purpose computer 4 running diagnostic software communicates with an interface unit 6 to generate a serial data signal 8 and a clock signal 10 which are used to communicate with the target integrated circuit 2. The clock signal 10 has timing characteristics which form sampling-trigger characteristics, e.g. sampling of the serial data signal 8 by the target integrated circuit 2 is performed upon received rising edges of the clock signal 10. It will be appreciated that other arrangements are possible, such as triggering of falling edges or triggering of both rising and falling edges. It will also be appreciated that multiple serial data signals 8 may be provided all with their sampling points controlled by the clock signal 10.

FIG. 2 illustrates a portion of the interface circuit 6. A FIFO memory 12 receives data values to be transferred to the target integrated circuit 2. These are output in a bitwise fashion to a pipeline 14 where respective stages of the pipeline hold respective adjacent bit values. A sampling point controller 16 is responsive to the values held within the different stages of the pipeline 14 and in dependence upon these controls the assertion of the values on the serial data signal and the clock signal. The sampling point controller 16 receives an internal clock signal which is a regular square wave. In the case of using rising edges of this clock signal as sampling-trigger characteristics, the sampling point controller 16 operates to suppress selected pulses in the internal clock signal so as to generate a clock signal for output as the clock signal 10 and supply to the target integrated circuit 2. When the sampling point controller 16 detects a change in adjacent data bits to be output, then in the case where the system is setup time constrained, the next clock pulse will be suppressed and the assertion of the new data value will be extended. This is illustrated in FIG. 2. The extended assertion of what in this case is a serial data value “0” then meets the minimum setup time requirements of the target integrated circuit 2 before the sampling of that new data value is triggered by the rising edge 18 of the clock signal 10.

FIG. 3 is a signal diagram illustrating the relationship between a given data sequence to be output as the serial data signal and a clock signal subject to extension of the time between sampling-trigger characteristics in accordance with the present technique. The example of FIG. 3 illustrates how the minimum hold time requirements associated with bit value changes can be met. As illustrated, when the bit value does not change, the clock signal can proceed at its full rate with serial data values sampled at rising edges of the clock. When a change in the bit value to be output is detected by the sampling point controller 16 (which includes a change detector), then the next pulse of the clock signal is suppressed (i.e. the next rising edge is suppressed) and the old bit value continues to be asserted for a longer period of time so as to meet the minimum hold time requirements. The data value is then changed and the new data value sampled upon the next rising edge of the clock signal which occurs.

FIG. 4 illustrates the same data sequence, but in this case being subject to a minimum setup time requirement. When a change in data value is detected, the new data value is asserted and the next clock pulse is suppressed. The new data value continues to be asserted during the period corresponding to the suppressed clock pulse so as to meet the minimum setup time requirements. The following clock pulse is then used to sample the now appropriately stable new data value.

It will be appreciated that the techniques illustrated in FIG. 3 and FIG. 4 could also be used in combination with a system which has both minimum hold time requirements and minimum setup time requirements. This would result in more clock pulses being suppressed and a lower data transfer rate, but would nevertheless yield an improvement over the system in which the minimum setup time and minimum hold time were always enforced even when no change in the data value occurred.

FIG. 5 is a flow diagram schematically illustrating example control performed by the sampling point controller 16 when using a clock gating approach. At step 20 a determination is made by the change detector as to whether the next data bit to be output is different from the current data bit. If there is no change in the current data bit, then the setup time requirement for the new data bit has already been met and the hold time requirement for the current data bit will automatically be satisfied by the hold time of the next bit. Processing proceeds to step 21 where the next data value is nominally output (even though it is the same as the previous value) so as to at least advance the working point (index position) within the data stream. If there is a difference in these data bit values, then step 22 determines whether the minimum hold time for the current data bit has been met. If this requirement has not been met, then processing proceeds to step 24, at which the next sampling-trigger characteristic of the clock signal is suppressed by suppressing the next clock pulse. Step 26 then continues the assertion of the current data bit so as to exceed the minimum hold time requirements of the system. Once these minimum hold time requirements have been exceeded, then step 28 asserts the next data bit.

If the determination at step 22 was that the minimum hold time for the current data bit has been met, then step 30 proceeds to assert the next data bit. Step 32 then determines whether the minimum set up time for the next data bit (i.e. the one that has just been asserted at step 30) has been met. If the minimum setup time has not been met, then step 34 serves to suppress the next sampling-trigger characteristic of the clock signal by suppressing the next clock pulse. Step 36 then extends the assertion of the next data bit to meet the minimum setup time requirement up to the point of the next sampling-trigger point following the one which was suppressed.

FIG. 6 is a flow diagram illustrating control processes performed by the sampling point controller of FIG. 2 in an embodiment more suited to FPGA implementation.

At step 38 a determination is made as to whether the next bit value to be output D_{N+1} is not equal to the previous bit value D_{N}. If these bit values are not equal, then processing proceeds to step 40 at which a determination is made as to whether the minimum hold time for the previous bit value D_{N} has been met. If this hold time has not been met, then the processing loops through step 42 which delays for one internal interval (internal clock period) of the sampling point controller until the minimum hold time requirement of step 40 is met. If the determination at step 38 is that the next bit value D_{N+1} is equal to the previous bit value D_{N}, then step 39 outputs this next bit value D_{N+1} to advance the working point (index position) within the data stream.

When the minimum hold time requirement at step 40 is met, then processing proceeds to step 42 at which the next data bit value D_{N+1} is output. Step 44 then determines whether the minimum setup time for that data value D_{N+1} has been met. If this minimum setup time has not been met, then processing loops through step 46 inserting another internal delay interval until the requirement is met. Once the minimum setup time for the new data value is met, processing proceeds to step 48 at which a determination is made as to whether the minimum time between sample triggers has been met. In some systems there will be a minimum time which is supported between sample triggers. If this minimum time has not been met then processing loops through step 50 where a delay of one internal interval is inserted into the minimum time between sample triggers is met. When the minimum time between sample triggers is met, processing proceeds to step 52 at which the next sample trigger is asserted on the clock signal and the processing ends (or returns to step 38).

It will be appreciated that the above represents particular example embodiments of the use of the present techniques. There are many variations which are possible. Example variations include the use of a register in place the FIFO memory 12 in FIG. 2. In this case, a data value representing a sequence of serial bits to be output is loaded into the register and read in a bitwise fashion from the register. When the end of the register is reached, then the next data value is loaded and wrapping performed to start from the other end of the register now holding the new data value. Another example alteration would be instead of suppressing clock pulses as is described in the above embodiment, clock pulses could instead be stretched/extended by appropriate gating. There are many other possible modifications within the scope of the technique.

1. Apparatus for generating a serial data signal and a clock signal, said clock signal having sampling-trigger characteristics indicating respective sampling points for extracting data bits from said serial data signal, said apparatus comprising:
a pipeline operable to queue a sequence of data bits to be output using said serial data signal;
a bit value change detector coupled to said pipeline store and operable to detect changes of value between adjacent data bits queued within said pipeline;
a sampling point controller responsive to said detected changes of value to selectively extend a time between said sampling-trigger characteristics of said clock signal and to extend a time for which a value of one of said adjacent data bits is asserted as said serial data signal.

2. Apparatus as claimed in claim 1, wherein if said bit value change detector detects a subject data bit in said sequence adjacent a preceding data bit having different bit value, then said sampling point controller acts to delay said sampling-trigger characteristic within said clock signal indicating a sampling point for said subject data bit whilst extending assertion time of said subject data bit as said serial data signal thereby increasing a setup time for said subject data bit.

3. Apparatus as claimed in claim 1, wherein if said bit value change detector detects a subject data bit in said sequence adjacent a following data bit having different bit value, then said sampling point controller acts to delay said sampling-trigger characteristic within said clock signal indicating a sampling point for said following data bit whilst extending assertion time of said subject data bit as said serial data signal thereby increasing a hold time for said subject data bit.

4. Apparatus as claimed in claim 1, wherein said sampling-trigger characteristics are one or more of:
a rising edge of said clock signal; and
a falling edge of said clock signal.

5. Apparatus as claimed in claim 1, wherein said sampling-trigger characteristics are one of a rising edge of said clock signal and a falling edge of said clock signal and said apparatus for generating has an internal clock signal with an internal clock frequency at least two times greater than a clock frequency of said clock signal when said time between sampling-trigger characteristics is extended.

6. Apparatus as claimed in claim 1, wherein said sampling-trigger characteristics are both a rising edge of said clock signal and a falling edge of said clock signal and said apparatus for generating has an internal clock signal with an internal clock frequency at least greater than a clock frequency of said clock signal when said time between sampling-trigger characteristics is extended.

7. Apparatus as claimed in claim 1, wherein said serial data signal and said serial clock signal are diagnostic signals for communicating with an integrated circuit.

8. Apparatus as claimed in claim 7, wherein said diagnostics signals are operable to perform one or more of:
debug operations;
trace operations;
manufacturing test operations; and
programming of said integrated circuit.

9. Apparatus as claimed in claim 1, wherein
said apparatus generates a plurality of serial data signals with respective pipelines and bit value change detectors and with sampling points indicated by sampling-trigger characteristics of said clock signal; and
in response to a detected change of value in one of said serial signals, said sampling point controller extends a time between said sampling-trigger characteristics of said clock signal and correspondingly extends a time for which a value of one of said adjacent data bits of said serial data signal changing is asserted.

10. Apparatus for generating a serial data signal and a clock signal, said clock signal having sampling-trigger characteristics indicating respective sampling points for extracting data bits from said serial data signal, said apparatus comprising:
pipeline means for queuing a sequence of data bits to be output using said serial data signal;
bit value change detector means coupled to said pipeline store for detecting changes of value between adjacent data bits queued within said pipeline means;
sampling point controller means responsive to said detected changes of value for selectively extending a time between said sampling-trigger characteristics of said clock signal and correspondingly extending a time for which a value of one of said adjacent data bits is asserted as said serial data signal.

11. A method of generating a serial data signal and a clock signal, said clock signal having sampling-trigger characteristics indicating respective sampling points for extracting data bits from said serial data signal, said comprising the steps of:
queuing a sequence of data bits to be output using said serial data signal;
detecting changes of value between adjacent data bits queued;
in response to said detected changes of value, selectively extending a time between said sampling-trigger characteristics of said clock signal and extending a time for which a value of one of said adjacent data bits is asserted as said serial data signal.

12. A method as claimed in claim 11, wherein if a subject data bit in said sequence adjacent a preceding data bit having different bit value is detected, then said sampling-trigger characteristic within said clock signal indicating a sampling point for said subject data bit is delayed whilst extending assertion time of said subject data bit as said serial data signal thereby increasing a setup time for said subject data bit.

13. A method as claimed in claim 11, wherein if a subject data bit in said sequence adjacent a following data bit having different bit value is detected, then said sampling-trigger characteristic within said clock signal indicating a sampling point for said following data bit is delayed whilst extending assertion time of said subject data bit as said serial data signal thereby increasing a hold time for said subject data bit.

14. A method as claimed in claim 11, wherein said sampling-trigger characteristics are one or more of:
a rising edge of said clock signal; and
a falling edge of said clock signal.

15. A method as claimed in claim 11, wherein said sampling-trigger characteristics are one of a rising edge of said clock signal and a falling edge of said clock signal and said method of generating uses an internal clock signal with an internal clock frequency at least two times greater than a clock frequency of said clock signal when said time between sampling-trigger characteristics is extended.

16. A method as claimed in claim 11, wherein said sampling-trigger characteristics are both a rising edge of said clock signal and a falling edge of said clock signal and said method of generating uses an internal clock signal with an internal clock frequency at least greater than a clock frequency of said clock signal when said time between sampling-trigger characteristics is extended.

17. A method as claimed in claim 11, wherein said serial data signal and said serial clock signal are diagnostic signals for communicating with an integrated circuit.

18. A method as claimed in claim 17, wherein said diagnostics signals are operable to perform one or more of:
debug operations;
trace operations;
manufacturing test operations; and
programming of said integrated circuit.

19. A method as claimed in claim 11, wherein
said method generates a plurality of serial data signals with respective queues and value change detection and with sampling points indicated by sampling-trigger characteristics of said clock signal; and
in response to a detected change of value in one of said serial signals, extending a time between said sampling-trigger characteristics of said clock signal and extending a time for which a value of one of said adjacent data bits of said serial data signal changing is asserted.
